(19) United States
(12) Patent Application Publication
(10) Pub. No.: US 2005/0160302 A1
(43) Pub. Date: Jul. 21, 2005

(54) Power management apparatus and method

(75) Inventors: Takayuki Asakura, Yamato-shi (JP); Takonobu Nakao, Tokyo (JP); Kozo Matsunaga, Yokohama-shi (JP); Yasumasa Takeda, Kanagawa-ken (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 11/036,874

(22) Filed: Jan. 14, 2005

(30) Foreign Application Priority Data
Jan. 16, 2004 (JP) 2004-009090

(51) Int. Cl. G06F 1/26

(52) U.S. Cl. 713/320; 370/404

(57) ABSTRACT

In order to conserve power in a computer display, an apparatus is provided to switch the display to a power-saving mode when, for example, no operation has been performed on the computer for some predetermined time. In the power-saving mode, a full-screen black screen is displayed behind any currently active window. Information about window location and activity is acquired and maintained to improve efficiency. Power-saving mode may be exited explicitly or in response to activity. Window order and display may also be switched on the fly appropriately.

### BACKGROUND OF THE INVENTION

1. Field Of The Invention

The present invention relates to a power management apparatus for executing power management to reduce power consumption of a display.

2. Background

Computers are generally provided with a power management function. The power management function is a function for reducing the power consumption of a computer by performing a predetermined processing when the computer has not been used for a predetermined time. In the case of reducing the power consumption of a display, it is conceivable to perform processings such as cutting the power supply to the display and activating a screen saver.

Today, multi-window OS's are widely used as an operating system (hereinafter referred to as an “OS”). A multi-window OS is an OS which makes it possible to Today, multi-window OS's are widely used as an operating system (hereinafter referred to as an “OS”). A multi-window OS is an OS which makes it possible to open multiple windows at the same time and execute different programs on the respective windows. A user can efficiently execute the multiple programs at the same time, moving the windows on the screen with the use of a pointing device such as a mouse and changing the sizes of the windows.

When programs are executed under the control of a multi-window OS to perform works, it is often only the window being currently operated and focused on (hereinafter referred to as “the active window”) that is actually required even though multiple windows are displayed on the screen. Conventionally, it has been attempted to execute power management only for the portions other than the active window in the case where the above situation is assumed.

For example, Published Unexamined patent application No. 10-171433 discloses techniques where image data for hiding the entire screen, image data for an active window and image data for other windows which have been registered in advance are synthesized and written in a VRAM. That is, transfer of all the screens to the VRAM is performed beyond the management of the multi-window OS, and the window for hiding the full screen is not displayed as a window managed by the multi-window OS. There is a problem that it is not easy to display a new window or hide a window already displayed after execution of power management. That is, in order to perform such display/nondisplay switching operation of a window after execution of power management, it is necessary to once terminate the power management and re-register setting of display/nondisplay for windows.

Also, Published Unexamined patent application No. 10-78946 includes techniques whereby the region which does not include an active window on the display is hidden (powered off) beyond the management of a multi-window OS. Specifically, under the control of a timer, the region where no work is performed is hidden when a predetermined time has elapsed. Accordingly, there is a problem that a user cannot intentionally display/hide (power on/off) a window when power management is executed. Therefore, when the user attempts to work on a second window watching a first window, for example, the region including the first window may be hidden. It may also happen that the power for all the region of the screen is on when the mouse is moved across the full screen.

Furthermore, in these prior-art techniques, power management is performed without verifying whether the power management is effective or not and there is doubt whether power management is effectively performed.

### SUMMARY OF THE INVENTION

The present invention has been made to solve the technical problems described above, and its object is to make it possible to easily switch display/non-display of windows after power management is executed.

Another object is to cause power management to be executed only when the power management effect is high.

In order to achieve these objects, and other objects which shall be apparent to persons of ordinary skill in the relevant arts, in accordance with the present invention, a special application program is prepared so that a black full-screen window is opened as a window managed by a multi-window OS. The order of windows is adjusted by the control of the multiple-window OS, and thereby power consumption of a system is reduced. That is, a first power management apparatus of the present invention is a power management apparatus for executing power management to reduce the power consumption of a display, the power management apparatus comprising: a mode switching determination section for determining to switch to a power-save mode if a predetermined condition is satisfied; a full-screen window display section for displaying on the display a full-screen window for reducing the power consumption of the display if switching to the power-save mode has been determined by the mode switching determination section; and a window switching section for hiding a window displayed on the front of the full-screen window behind the full-screen window and/or displaying a window hidden behind the full-screen window on the front of the full-screen window, in response to a window switching direction given in a state where the full-screen window is displayed. In this case, the full-screen window display section corresponds to a functional section of a full-screen window opening module, a window information acquisition module and a window arrangement module to be described later. The window switching section may be realized as a function of an OS as in a first embodiment to be described later, or may be realized as a function of an application program as in a second embodiment to be described later. By having such a configuration, the present invention is capable of switching display/nondisplay of windows even after execution of power management.

The present invention can be grasped as a computer provided with a particular user interface. In this case, the computer of the present invention comprises: a full-screen window opening section for opening a black full-screen window; a window switching user interface (UI) generation section for generating a window switching Ul for giving a direction to hide a window displayed on the front of the full-screen window behind the full-screen window and/or to display a window hidden behind the full-screen window on the front of the window; and a display section for displaying the full-screen window opened by the full-screen window opening section and the window switching UI generated by the window switching UI generation section.

Furthermore, the present invention can be grasped as a method for executing power management to reduce the power consumption of a system by adjusting the order of windows under the control of a multi-window OS. In this case, the power management method of the present invention is a power management method for executing power management to reduce the power consumption of a computer display, the power management method comprising the steps of: determining switching to a power-save mode if a predetermined condition is satisfied; displaying on the display a full-screen window for reducing the power consumption of the display if switching to the power-save mode has been determined; and hiding a window displayed on the front of the full-screen window behind the full-screen window and/or displaying a window hidden behind the full-screen window on the front of the full-screen window, in response to a window switching direction given in a state where the full-screen window is displayed.

The present invention can be grasped as a computer program product. In this case, a first program product of the present invention is a program product,including: a program storage device readable by a computer and a program of instructions tangibly embodied on the program storage device and executable by the computer to perform method steps for executing power management to reduce the power consumption of a display,the method steps comprising: determining to switch to a power-save mode if a predetermined condition is satisfied; displaying on the display a full-screen window for reducing the power consumption of the display if switching to the power-save mode has been determined; and hiding a window displayed on the front of the full-screen window behind the full-screen window and/or displaying a window hidden behind the full-screen window on the front of the full-screen window, in response to a window switching direction given in a state where the full-screen window is displayed. Furthermore, a second program product of the present invention is a program product, including: a program storage device readable by a computer and a program of instructions tangibly embodied on the program storage device and executable by the computer to perform method steps for executing power management to reduce the power consumption of a display of a the computer on which a multi-window OS is running, the method steps comprising: giving the multi-window OS a direction to open a full-screen window for reducing the power consumption of the display; acquiring information on a different window already opened, from the multi-window OS; and giving the multi-window OS a direction to display and/or hide the different window on the front of and/or behind the full-screen window.

### BRIEF DESCRIPTION OF THE DRAWINGS

Embodiments of the present invention will be described in some detail in the following specification and with reference to the following figures in which like elements are referred to using like reference numbers and in which:

FIG. 1 shows the hardware configuration of a computer system to which the present invention is applied;

FIG. 2 is a block diagram showing the functional configuration of a computer system in a first embodiment;

FIG. 3 is a flowchart showing the operation of a PM application in the first embodiment to be performed before switching to a power save mode is performed;

FIG. 4-1 shows examples of display to be made on a display in the first embodiment;

FIG. 4-2 shows examples of display to be made on the display in the first embodiment;

FIG. 5 is a flowchart showing the operation of terminating the power save mode by the PM application in the first embodiment;

FIG. 6 schematically shows relationships among windows in the first embodiments;

FIG. 7 is a block diagram showing the functional configuration of a computer system in a second embodiment;

FIG. 8 shows examples of display to be made on a display in the second embodiment;

FIG. 9 shows examples of display to be made on the display in the second embodiment; and

FIG. 10 is a flowchart showing the operation of switching display/non-display of windows to be performed by a PM application in the second embodiment.

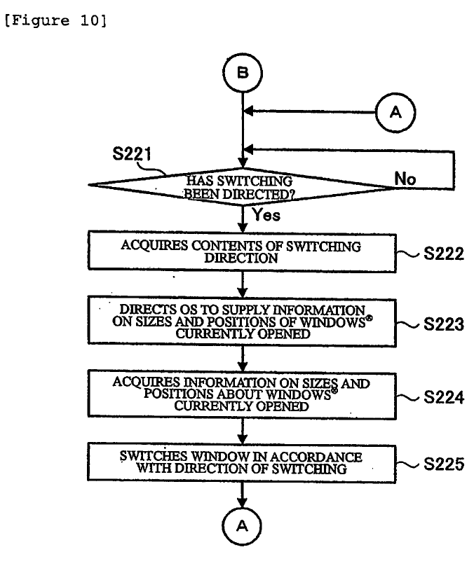

### DETAILED DESCRIPTION OF EMBODIMENTS OF THE PRESENT INVENTION

Embodiments for implementing the present invention (hereinafter referred to as “embodiments”) will be described in detail below with reference to accompanying drawings.

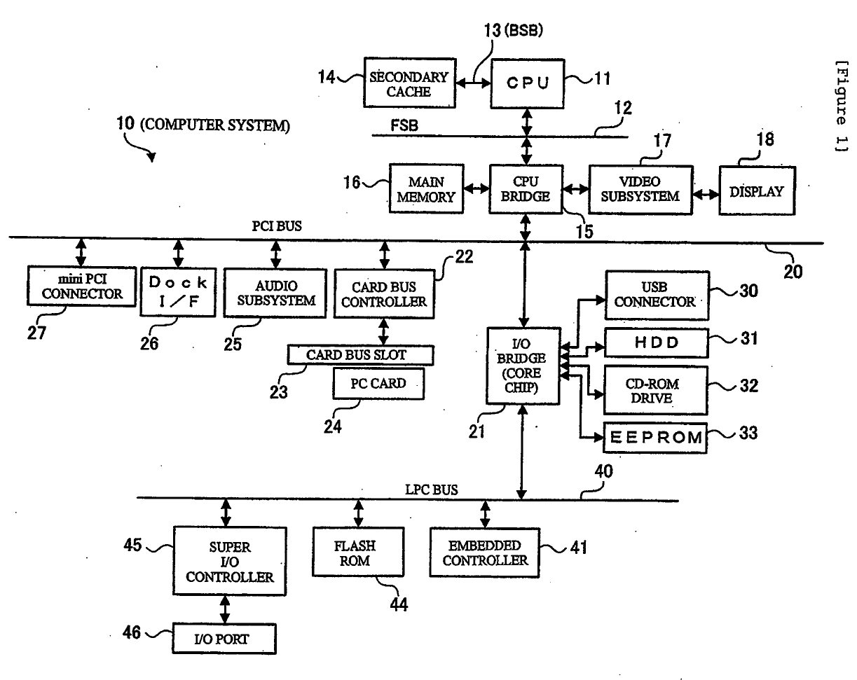

FIG. 1 shows the hardware configuration of a computer system 10 to which the embodiments are applied. A computer to be provided for the computer system 10 (which may be hereinafter referred to simply as a “system” ) is configured, for example, as a notebook-type personal computer (notebook PC) mounted with a multi-window OS.

In the computer system 10 shown in FIG. 1, a CPU 11 functions as a brain of the entire computer system 10 and executes various programs in addition to utility programs under the control of an OS. The CPU 11 is mutually connected to each of components via three stages of buses, that is, a front side bus (FSB) 12 which is a system bus, a peripheral component interconnect (PCI) bus 20 as a bus for high-speed I/O devices and a low pin count (LPC) bus 40 as a bus for I/O devices. The CPU 11 stores program codes and data in a cache memory to speed up processings. Though an SRAM with 128 KB or so is integrated within the CPU 11 as a primary cache recently, there is also provided a secondary cache 14 with 512 KB to 2 MB via a back side bus (BSB) 13, which is a dedicated bus, in order to make up for a deficiency of capacity. It is also possible to avoid a package with a lot of terminals by connecting the secondary cache 14 to the FSB 12 without using the BSB 13 to keep the cost low.

Mode control can be performed on the CPU 11 used here, and, for example, it can be operated in a standard mode or in a low-speed mode (a low power mode). Methods for speeding down the operation of the CPU 11 includes the SpeedStep technique by Intel Corporation in the U.S. (for reducing the operating frequency and operating voltage of a processor) and a slottling technique (a method for making a pseudo-reduction of the operating frequency by periodically turning on/off a processor). By operating the CPU 11 in the low-speed mode, it is possible to reduce the clock of the CPU 11 from usual 850 MHz to 750 MHz and the voltage of the CPU 11 from usual 1.6 V to 1.35 V.

The FSB 12 and the PCI bus 20 are connected to each other via a CPU bridge (a host-PCI bridge) 15 called a memory/PCI chip. The CPU bridge 15 is configured to include a memory controller function for controlling operation of access to a main memory 16, a data buffer for absorbing the data transfer rate difference between the FSB 12 and the PCI bus 20, and the like. The main memory 16 is a writable memory used as an area where execution programs for the CPU 11 are to be read in or as a work area where data to be processed by the execution programs is to be written in. The main memory 16 is configured, for example, by multiple DRAM chips. Its standard capacity is, for example, 64 MB and expansion up to 320 MB is possible. The execution programs include an OS and various drivers for operating peripheral equipment, application programs to be applied to particular works, and firmware such as a basic input/output system (BIOS) stored in a flash ROM 44 to be described later.

A video subsystem 17 is a subsystem for realizing functions related to video, which includes a video controller. The video controller processes a rendering instruction from the CPU 11, writes processed rendering information in a video memory, and reads the rendering information from the video memory to output it to a display 18 as rendering data.

The PCI bus 20 is a bus capable of relatively high speed data transfer and is standardized by the following specification: the data bus width of 32 bits or 64 bits, the maximum operating frequency of 33 MHz or 66 MHz, and the maximum data transfer rate of 132 MB/s or 528 MB/s. To the PCI bus 20, there are connected an I/O bridge 21, a card bus controller 22, an audio subsystem 25, a docking station interface (Dock I/F) 26, a mini PCI connector 27.

The I/O bridge 21 is provided with a function of a bridge between the PCI bus 20 and the LPC bus 40. It is also provided with a DMA controller function, a programmable interruption controller (PIC) function, a programmable interval timer (PIT) function, an integrated device electronics (IDE) interface function, a universal serial bus (USB) function and a system management bus (SMB) interface function, and includes a real-time clock (RTC) therein.

The DMA controller function is a function for performing data transfer between peripheral equipment such as an FDD and the main memory 16 without intervention of CPU 11. The PCI function is a function for causing a predetermined program (an interrupt handler) to be executed, in response to an interrupt request (IRO) from peripheral equipment. The PIT function is a function for causing a timer signal to be generated in a predetermined cycle. To the interface realized by the IDE interface function, an IDE hard disk drive (HDD) 31 is connected, and in addition, a CD-ROM drive 32 is connected via an attachment packet interface (ATAPI). A different type of IDE equipment may be connected, such as a digital versatile disc (DVD) drive, in stead of the CD-ROM drive 32. External storage devices such as the HDD 31 and the CD-ROM drive 32 are placed in a containing place called “a media bay” or “a device bay” in a notebook PC body, for example. These standard external storage devices may be attached in an exclusively exchangeable manner for other equipment such as an FDD and a battery pack. The I/O bridge 21 is provided with a USB port, and the USB port is connected to a USB connector 30 provided on the wall of the notebook PC body. Furthermore, an EEPROM 33 is connected to the I/O bridge 21 via an SM bus. The EEPROM 33 is a memory for holding information such as a password registered by a user, a supervisor password and a manufacturer's serial number, which is non-volatile and the stored contents of which can be electrically rewritable.

The card bus controller 22 is a dedicated controller for directly linking a bus signal of the PCI bus 20 to an interface connector (a card bus) of a card bus slot 23, and a PC card 24 can be fitted into the card bus slot 23.

The audio subsystem 25 is a chip (a sound chip) for outputting sounds and creates sounds either in an FM sound source method or in a PCM sound source method. The FM sound source method is a method of synthesizing tones by combining a modulating signal called “a modulator” with a sine-wave signal. The PCM sound source method is a method of creating tones by converting presence/absence or strength/weakness of sounds stored as digital data into waveform data. A docking station interface 26 is hardware for connecting a docking station (not shown), which is an expanded apparatus of the computer system 10. When a notebook PC is set on the docking station, various hardware elements connected to an internal bus in the docking station are connected to the PCI bus 20 via the docking station interface 26. A mini PCI card is connected to the mini PCI connector 27.

The LPC bus 40 is of an interface standard for connecting a legacy device to a system without an ISA bus, and sending and receiving commands, addresses and data using the same four signal lines (for LAD signals) at an operating clock of 33 MHz (for example, 8 bits of data are transferred at 4 bits'2 clocks). To the LPC bus 40, an embedded controller 41, a flash ROM 44 and a super I/O controller 45 are connected. The LPC bus 40 is also used to connect peripheral equipment operating at a relatively low speed, such as a keyboard/mouse controller. An I/O port 46 is connected to the super I/O controller 45 to control driving of an FDD, input/output of parallel data (PIO) via a parallel port and input/output of serial data (SIO) via a serial port. The flash ROM 44 is a ROM for which deletion and new writing of data can be electrically performed as a batch or for each block, and the BIOS is stored therein as described above.

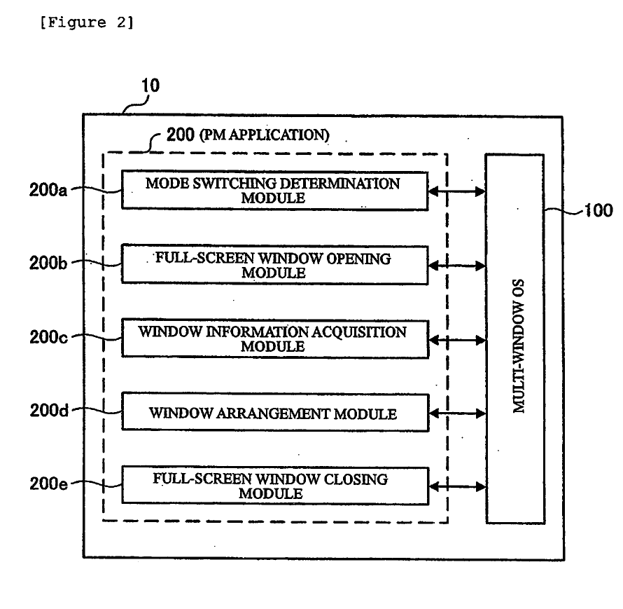

FIG. 2 is a block diagram showing the configuration of a multi-window OS 100 and a power management application program (hereinafter referred to as “a PM application”) 200 which operate on the computer system 10 according to the first embodiment. As shown in FIG. 2, the PM application 200 is configured by a mode switching determination module 200a, a full-screen window opening module 200b, a window information acquisition module 200c, a window arrangement module 200d and a full-screen window closing module 200e.

The mode switching determination module 200a is a module for determining to switch to a power save mode in a state where a predetermined condition is satisfied.

The full-screen window opening module 200b is a module for directing the multi-window OS to open a full-screen window for reducing the power consumption of a display, for example, a black full-screen window.

The window information acquisition module 200c is a module for acquiring information on windows currently opened from the multi-window OS.

The window arrangement module 200d is a module for directing the multi-window OS to arrange windows so that an active window among the windows currently opened is to be displayed on the front of the full-screen window opened by the full-screen window opening module 200b.

The full-screen window closing module 200e is a module for directing the multi-window OS to close the full-screen window, in response to a direction to terminate the power save mode.

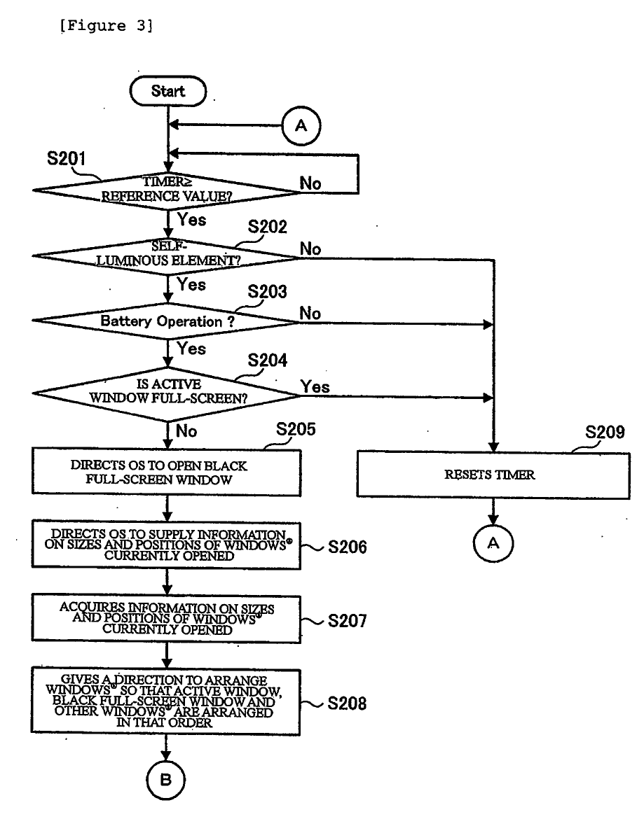

FIG. 3 is a flowchart showing the operation of the PM application according to this embodiment.

The mode switching determination module 200a determines whether or not the time for which no operation has been performed on the computer system 10 has reached a predetermined period of time (reference value) (step 201). If the time has not reached the reference value, the step 201 is repeated. If the time has reached the reference value, the process proceeds to step 202.

Then, the mode switching determination module 200a determines whether or not a self-luminous element display device, such as an organic electroluminescence display, is currently active (step 202). Such determination can be performed by using a program part for recognizing what kind of device the display device currently making display is, for example, OEMDSPIF.DLL. According to this embodiment, the power consumption of a display is reduced by displaying a black full-screen window. Such a method is especially effective to a self-luminous element display device but is not so effective to a liquid crystal display (LCD) and a cathode ray tube (CRT) display. Accordingly, such determination is performed so that switching to the power save mode is determined only when the effect of power management can be expected. As a result of the determination, if a self-luminous element display device is active, then the process proceeds to step 203.

The mode switching determination module 200a determines whether or not the computer system 10 operates with a battery (step 203). Since use of a notebook PC is assumed in this embodiment, it is not necessary to perform power management in the case of an AC mode. Accordingly, such determination is performed so that switching to the power save mode is determined only when power management is required. As a result of the determination, if the computer system 10 operates with a battery, the process proceeds to step 204.

The mode switching determination module 200a determines whether or not full-screen display is set for an active window (step 204). According to this embodiment, an active window is displayed on the front of a black full-screen window. Therefore, if full-screen display is set for an active window, it is meaningless to display the black full-screen window. Accordingly, such determination is performed so that switching to the power save mode is determined only when the effect of power management can be expected. As a result of the determination, the process proceeds to step 205 only when full-screen display is not set for the active window, and control is handed to the full-screen window opening module 200b.

Though switching to a power save mode is automatically performed based on conditional determination by the mode switching determination module 200a here, a user may explicitly direct switching to the power save mode.

The full-screen window opening module 200b issues an instruction to open a black full-screen window to the multi-window OS (step 205). Specifically, an application program interface (API) is called to communicate the instruction to the multi-window OS. In response to this, the multi-window OS opens a black full-screen window and returns notification that the instruction has been completed to the PM application 200.

Then, the window information acquisition module 200c issues an instruction to acquire information on the sizes and positions of all the windows currently opened to the multi-window OS (step 206). Specifically, an API is called and the instruction is communicated to the multi-window OS similarly to step 205. In response to this, the multi-window OS supplies the information on all the windows currently opened to the PM application 200.

Upon receiving the notification, the window information acquisition module 200c acquires the information on the sizes and positions of the windows currently opened (step 207). After that, the window arrangement module 200d issues an instruction to arrange the windows so that the active window is displayed on the front, the black full-screen window is displayed behind it, and the other windows are hidden behind the black full-screen window (step 208). In response to this, the multi-window OS arranges the windows in the specified order, displays them on the display and returns notification that the instruction has been completed to the PM application 200.

If it is determined that a self-luminous element display device is not active at step 202, or that the computer system 10 does not operate with a battery at step 203, or that full-screen display is set for the active window at step 204, then the timer is reset (step 209) and the process returns to step 201.

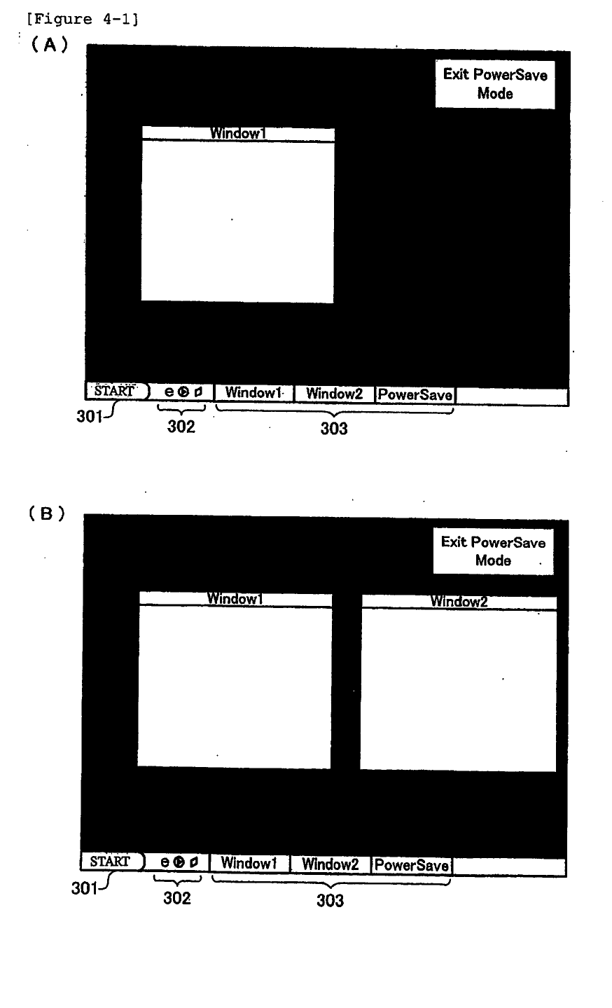

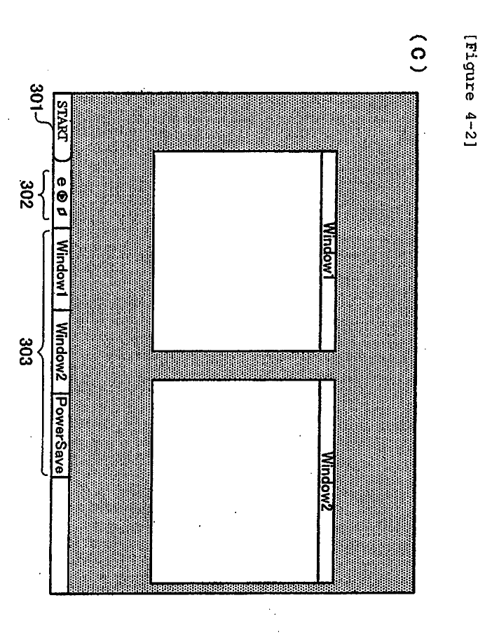

FIG. 4-1 (A) is an example of display made when the process in FIG. 3 ends. A black full-screen window is displayed, and “Window 1”, an active window, is displayed on the front the black full-screen window. At the upper right of the black full-screen window, an “Exit PowerSave Mode” button, a button for exiting the power save mode, is displayed.

At the lower side of the black full-screen window, a task bar is displayed. On the task bar, there are displayed a start button 301, a quick activation icons group 302, a window selection buttons group 303. The quick activation icons group 302 comprises icons for quickly activating software which is frequently used. In these icons, there is included an icon for quickly displaying a desk-top screen as shown on the rightmost of the icon group. The window selection buttons group 303 includes a button for selecting “Window 1” displayed on the front of the black full-screen window, a button for selecting “Window 2” hidden behind the black full-screen window and a button for selecting the black full-screen window (“PowerSave” window).

According to this embodiment, it is possible to select a window hidden behind the black full-screen window from among the window selection buttons group 303 displayed on the task bar to display it on the front of the black full-screen window.

For example, by pressing the “Window 2” portion on the task bar in the condition shown in FIG. 4-1(A), “Window 2” is displayed on the front of the black full-screen window as shown in FIG. 4-1 (B).

By pressing the “PowerSave” portion on the task bar, the black full-screen window can be brought onto the front, though this is not shown.

Furthermore, by pressing the icon at the rightmost of the quick activation icons group 302 on the task bar, the desk-top screen can be displayed while the power save mode is continued. After that, by pressing the “Window 1” and “Window 2” portions on the task bar, display as shown in FIG. 4-2(C) is made.

Furthermore, by pressing “Exit PowerSave Mode” at the upper right of the screen in the condition of FIG. 4-1 (A) or (B), the power save mode is terminated. First, the PM application 200 determines whether or not the user has directed termination of the power save mode (step 211). Specifically, it is determined whether or not an operation of the keyboard, the mouse and the like has been performed.

If it is determined that termination of the power save mode has been directed, control is handed to the full-screen window closing module 200e. The full-screen window closing module 200e issues an instruction to close the black full-screen window to the multi-window OS (step 212). Specifically, an API is called, and the instruction is communicated to the multi-window OS. In response to this, the multi-window OS closes the black full-screen window and returns notification that the instruction has been completed to the PM application 200.

After that, the PM application 200 resets the timer (step 213), and the process returns to step 201 in FIG. 3.

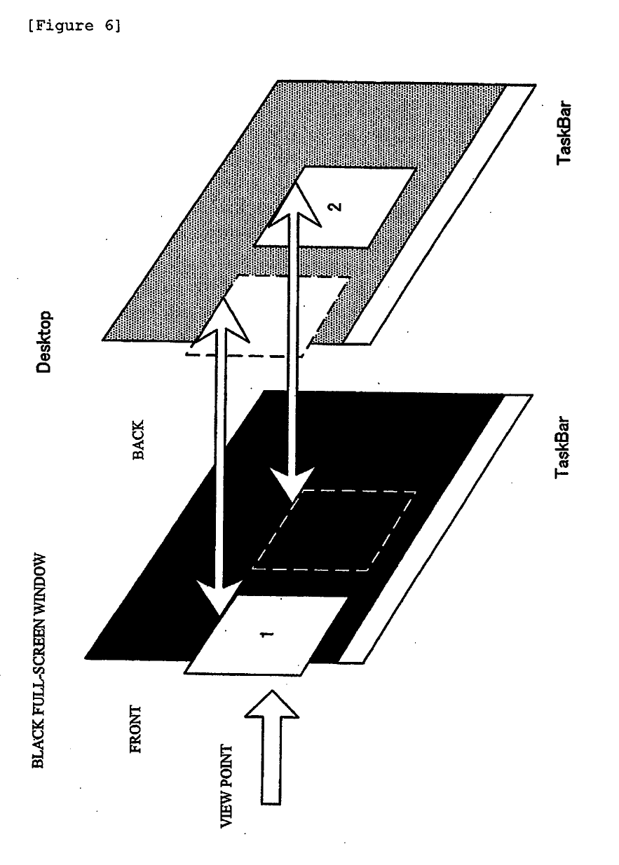

FIG. 6 shows that “Window 1” is located on the front of the black full-screen window, and “Window 2” is located behind the black full-screen window. The arrows in FIG. 6 show that “Window 1” displayed on the front of the black full-screen window can be hidden behind the black full-screen window, and that “Window 2” hidden behind the black full-screen window can be displayed on the front of the black full-screen window.

As described above, in this embodiment, the black full-screen window for reducing the power consumption of the display is displayed as a window managed by the multi-window OS. Thereby, it is possible to easily perform an operation of switching display/non-display of windows after switching to the power save mode. Furthermore, such switching operation can be performed with the use of a task bar conventionally provided for multi-window OS's, and thereby users familiar with the existing multi-window OS's can perform the operation without trouble.

When switching to the power save mode is performed because no operation has been performed for a predetermined period of time, it is achieved on the condition that a self-luminous element display device is active, the computer operates with a battery, and full-screen display is not set for an active window. Thereby, it is possible to perform power management more effectively.

In the first embodiment, switching of display/nondisplay of windows, after switching to a power save mode, is performed with the use of a task bar provided for a multi-window OS. In the second embodiment, however, there is provided a special user interface (a window switching UI) for switching display/nondisplay of windows after switching to a power save mode. If a request to switch display/nondisplay of windows is issued with the use of this window switching Ul, a PM application 200 give a switching direction to a multi-window OS.

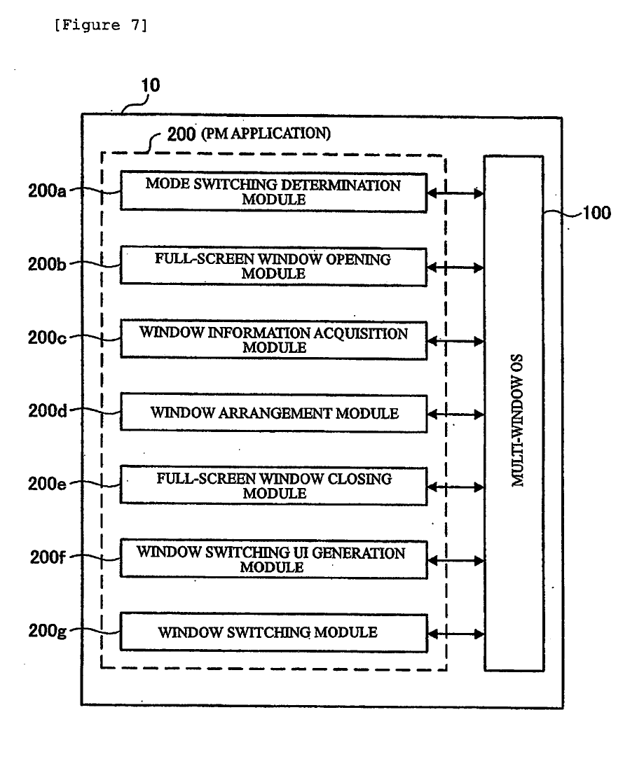

FIG. 7 is a block diagram showing the configuration of the multi-window OS 100 and the PM application 200 which operate on a computer system 10 in the second embodiment. As shown in FIG. 7, the PM application 200 is configured by a mode switching determination module 200a, a full-screen window opening module 200b, a window information acquisition module 200c, a window arrangement module 200d, a full-screen window closing module 200e, a window switching UI generation module 200f and a window switching module 200g.

The mode switching determination module 200a to the full-screen window closing module 200e are similar to those described in the first embodiment.

The window switching UI generation module 200f is a module for generating a window switching UI, which is a user interface used for requesting to switch display/nondisplay of windows.

The window switching module 200g is a module for directing the multi-window OS to change the arrangement of windows, in response to a request to switch display/nondisplay of windows issued with the use of the window switching UI.

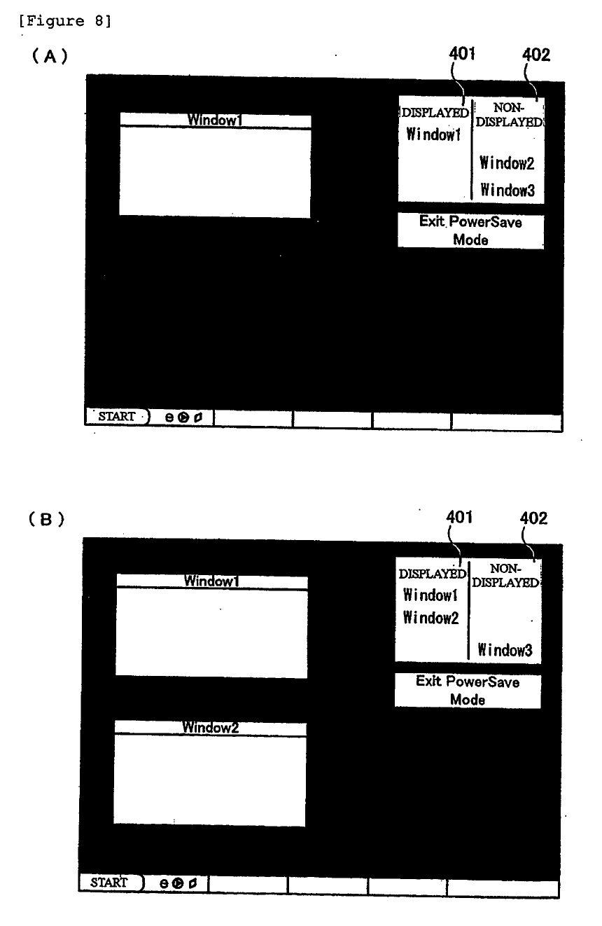

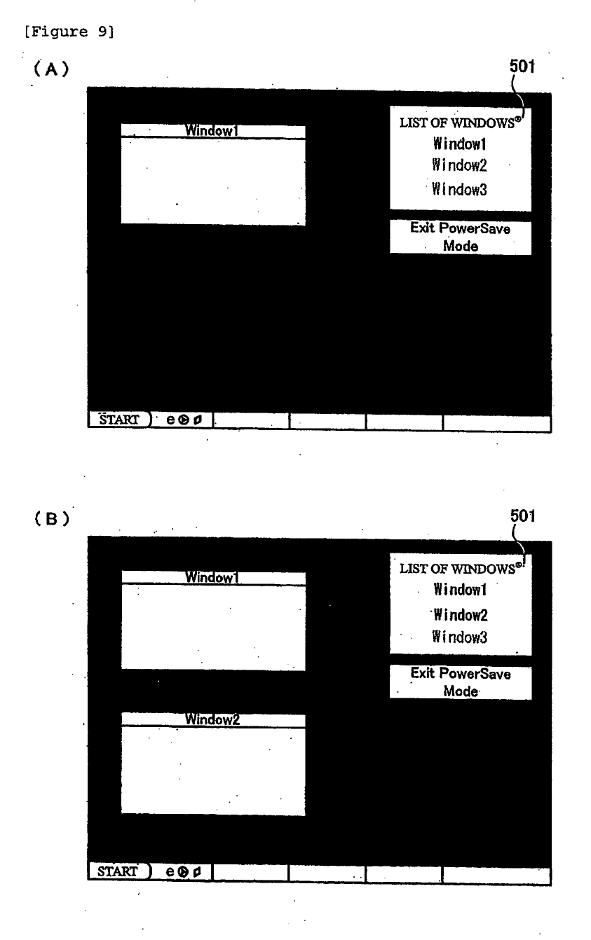

The operation to be performed before switching to the power save mode is performed and a black full-screen window is displayed substantially the same as that shown in FIG. 3. In this embodiment, however, when display of the black full-screen window is directed at steps 205 to 208, the window switching UI generation module 200f generates on the black full-screen window a window switching UI to be used to request switching of display/nondisplay of windows. Accordingly, the screen display made when the process in FIG. 3 ends is as shown in FIG. 8 or FIG. 9.

FIG. 8 shows an example of a window switching UI in which a section for displaying displayed windows information 401 is provided on the left side of a line segment indicating the black full-screen window and a section for displaying non-displayed windows information 402 is provided on the right of the line segment. In FIG. 8(A), by describing “Window 1” in the section for displaying displayed windows information 401, and “Window 2” and “Window 3” in the section for displaying non-displayed windows information 402, it is indicated that only “Window 1” is displayed on the front of the black full-screen window.

In this condition, it is possible, for example, to request “Window 2” to be displayed on front of the black full-screen window by double-clicking the “Window 2” described in the section for displaying non-displayed windows information 402 or by moving it into the section for displaying displayed windows information 401 by drug-and-dropping it. As a result, display of the window switching Ul is as shown in FIG. 8(B), and “Window 1” and “Window 2” are displayed on the front of the black full-screen window.

On the contrary, in FIG. 8(B), by double-clicking the “Window 2” described in the section for displaying information 401 on displayed windows or by moving it into the section for displaying non-displayed windows information 402 by drug-and-dropping it, the display as shown in FIG. 8(A) can be restored. FIG. 9 shows an example of a window switching Ul in which a window list display section 501 is provided. In this section, currently displayed windows are shown in normal color and non-displayed(hidden) windows are shown in gray.

In FIG. 9(A), by describing “Window 1” in normal color and “Window 2” and “Window 3” in gray, it is indicated that only “Window 1” is displayed on the front of the black full-screen window.

In this condition, it is possible, for example, to request “Window 2” to be displayed on the front of the black full-screen window by double-clicking the “Window 2” described in gray. As a result, display of the window switching UI is as shown in FIG. 9(B), and “Window 1” and “Window 2” are displayed on the front of the black full-screen window.

On the contrary, in FIG. 9(B), by double-clicking the “Window 2” to be shown in gray, the display as in FIG. 9(A) can be restored.

First, the PM application 200 determines whether or not the user has directed switching display/non-display of a window (step 221). Specifically, it is determined whether or not it has been directed with the use of the window switching UI shown in FIG. 8 or FIG. 9 to hide a window displayed on the front of the black full-screen window behind the full-screen window or to display a window hidden behind the black full-screen window on the front of the full-screen window.

If it is determined that switching of display/non-display of a window has been directed, then control is handed to the window switching module 200g, and the window switching module 200g acquires the contents of the switching direction (step 222).

The window information acquisition module 200c then issues an instruction to acquire information on the sizes and positions of all the windows currently opened to the multi-window OS (step 223). Specifically, an API is called, and the instruction is communicated to the multi-window OS. In response to this, the multi-window OS supplies the information on all the windows currently opened to the PM application 200.

Upon receiving this notification, the window information acquisition module 200c acquires information on the sizes and positions of the windows currently opened (step 224). After that, the window switching module 200g issues an instruction to rearrange the windows in accordance with the contents of the switching direction acquired at step 222 to the multi-window OS (step 225). In response to this, the multi-window OS rearranges the windows in the specified order, displays the windows on the display, and returns notification that the instruction has been completed to the PM application 200.

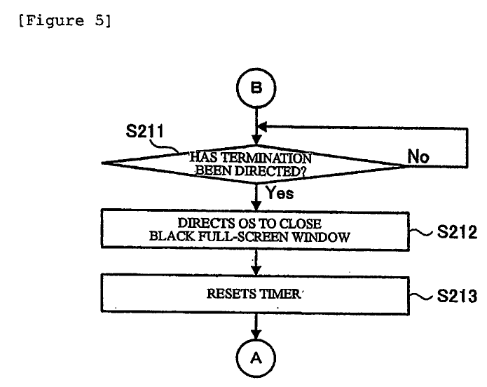

The operation of the PM application 200 to be performed when the power save mode ends is similar to that shown in FIG. 5.

As described above, according to this embodiment, the black full-screen window for reducing the power consumption of the display is displayed as a window managed by the multi-window OS. Thereby, it is possible to easily perform an operation of switching display/non-display of windows after switching to the power save mode. Furthermore, such switching operation can be performed with the use of an user interface, which is uniquely designed so that it is possible to intuitively recognize whether each window is on the front of or behind the black full-screen window, and thereby the operation of switching display/non-display of windows can be performed much more easily. Furthermore, in the case of switching to the power save mode because no operation has been performed for a predetermined period of time, it is achieved on the condition that a self-luminous element display device is active, that the computer operates with a battery, and that full-screen display is not set for an active window. Thereby, it is possible to perform power management more effectively.

Though an all black window is used as a full-screen window for reducing the power consumption of a display in the first and second embodiments described above, any window may be adopted only if it has the same effect.

In the first and second embodiments, description has been made on the assumption that the computer itself, which is equipped with a display to be provided with power management, has a function of executing the power management of the present invention. However, a mechanism for executing such power management may be provided outside the computer equipped with a display to be provided with power management.

The power management method in the embodiments may be developed as a program for causing a computer to execute power management for reducing the power consumption of a predetermined display. Alternatively, it may be developed as a program for causing a computer with a multi-window OS running thereon to execute power management for reducing the power consumption of the display of the computer. As a form of providing such programs for a computer, it is conceivable to install them in a notebook PC. In addition, it is also conceivable to provide them in a recording medium in which programs to be executed by a computer such as a notebook PC is stored in a manner that it can be read by the computer. Such a recording medium is, for example, a DVD or a CD-ROM. The program may be read by a DVD or CD-ROM reading device and the like, stored in a flash ROM and the like and then executed. Furthermore, such programs may be provided by a program transfer device via a network.

If the present invention is grasped as an invention of a recording medium as described above, it can be grasped as “a recording medium in which a program for causing a computer to execute power management to reduce the power consumption of a given computer display is stored, the program causing the computer to realize the functions of: determining switching to a power-save mode if a predetermined condition is satisfied; displaying on the display a full-screen window for reducing the power consumption of the display if switching to the power-save mode has been determined; and hiding a window displayed on the front of the full-screen window behind the full-screen window and/or displaying a window hidden behind the full-screen window on the front of the full-screen window, in response to a window switching direction given when the full-screen window is displayed.”

In this case, the function of displaying a full-screen window is also capable of displaying the full-screen window so that an active window among windows already displayed is to be displayed on the front of the full-screen window.

Alternatively, the invention of a recording medium may be “a recording medium in which a program for causing a computer to execute power management to reduce the power consumption of the display of a computer on which a multi-window OS is running is recorded, the program causing the computer to realize the functions of: giving the multi-window OS a direction to open a full-screen window for reducing the power consumption of the display; acquiring information on other windows already opened, from the multi-window OS; and giving the multi-window OS a direction to display and/or hide the other windows on the front of and/or behind the full-screen window.”

In this case, the function of giving a direction to display and/or hide the other windows is also capable of directing an active window among the other windows to be displayed on the front of the full-screen window.

Furthermore, the recording medium may be a recording medium in which a program is stored which is for further realizing a function of determining switching to a mode for executing each of the functions when a predetermined condition is satisfied. As the predetermined condition, it may be adopted that no operation has been performed on the computer for a predetermined period of time and display on the display is performed by a self-luminous element, that no operation has been performed on the computer for a predetermined period of time and the computer operates with a battery, or that no operation has been performed on the computer for a predetermined period of time and the full-screen window is not completely hidden by a different window when it is initially displayed.

Furthermore, the recording medium may be a recording medium in which a program is stored which is for realizing a function of giving the multi-window OS a direction to hide a window displayed on the front of the full-screen window behind the full-screen window and/or display a window hidden behind the full-screen window on the front of the full-screen window, in response to a window switching direction given when the full-screen window is displayed.

1. A power management apparatus for reducing the power consumption of a computer display, the power management apparatus comprising:
a mode switching determination module for, in response to a predetermined condition, switching the display to a power-saving operation mode;
a full-screen window display module for, in response to the display switching to the power-saving mode, displaying on the display a full-screen window for reducing the power consumption of the display; and
a window switching module for, in response to a window switching signal given in the power-saving mode, hiding a window displayed in front of the full-screen window behind the full-screen window and/or displaying a window hidden behind the full-screen window in front of the full-screen window.

2. The power management apparatus according to claim 1, wherein the full-screen window display module displays the full-screen window so that an active window among windows already displayed is displayed in front of the full-screen window.

3. The power management apparatus according to claim 1, wherein the mode switching determination module switches to the power saving operation mode if no operation has been performed on the computer for a predetermined time and display on the display is performed by a self-luminous element.

4. The power management apparatus according to claim 1, wherein the mode switching determination module switches to the power saving operation mode if no operation has been performed on the computer for a predetermined time and the computer is operating on battery power.

5. The power management apparatus according to claim 1, wherein the mode switching determination module switches to the power saving operation mode if no operation has been performed on the computer for a predetermined time and the full-screen window is not completely hidden by a different window already displayed.

6. A computer comprising:
a full-screen window opening module for opening a black full-screen window;
a window switching user interface (UI) generation module for generating a window switching UI for signaling the display to hide a window displayed in front of the full-screen window behind the full-screen window and/or to display a window hidden behind the full-screen window in front of the full-screen window; and
a display section for displaying the full-screen window opened by the full-screen window opening module and the window switching Ul generated by the window switching Ul generation module.

7. The computer according to claim 6, wherein the window switching Ul generation module displays information on the window displayed in front of the full-screen window in one portion of a screen separated by a mark indicating the full-screen window and information on the window hidden behind the full-screen window in the other portion of the screen.

8. The computer according to claim 6, wherein the window switching UI generation module displays information on the window displayed in front of the full-screen window and information on the window hidden behind the full-screen window in different display forms.

9. A power management method for reducing the power consumption of a computer display, the power management method comprising the steps of:
switching the display to a power-saving operation mode in response to a predetermined condition;
in response to switching the display to the power-saving mode, displaying on the display a full screen window for reducing the power consumption of the display; and
in response to a window switching signal given in said power-saving mode, hiding a window displayed in front of the full-screen window behind the full-screen window and/or displaying a window hidden behind the full-screen window in front of the full-screen window.

10. The power management method according to claim 9, wherein the step of displaying a full-screen window displays the full-screen window so that an active window among windows already displayed is displayed in front of the full-screen window.

11. A program product, comprising:
a program storage device readable by a computer and a program of instructions tangibly embodied on the program storage device and executable by the computer to perform method steps for executing power management to reduce the power consumption of a display, the method steps comprising:
switching the display to a power-saving mode if a predetermined condition is satisfied;
in response to switching the display to a power-saving mode, displaying on the display a full screen window for reducing the power consumption of the display; and
hiding a window displayed in front of the full-screen window behind the full-screen window and/or displaying a window hidden behind the full-screen window in front of the full-screen window, in response to a window switching signal received in a state where the full-screen window is displayed.

12. The program product according to claim 11, wherein the step of displaying a full-screen window comprises displaying the full-screen window so that an active window among windows already displayed is displayed in front of the full-screen window.

13. A program product, comprising:
a program storage device readable by a computer and a program of instructions tangibly embodied on the program storage device and executable by the computer to perform method steps for executing power management to reduce the power consumption of a display of a computer on which a multi-window OS is running, the method steps comprising:
directing the multi-window OS to open a full-screen window for reducing the power consumption of the display;
acquiring from the multi-window OS information on a different window which is already opened; and
directing the multi-window OS to display the different window in front of the full-screen window or to hide the different window behind the full-screen window, depending on the acquired information.

14. The program product according to claim 13, wherein the step of directing the OS to display or hide the different window comprises directing the OS to display an active window among the other windows in front of the full-screen window.

15. The program product according to claim 13, wherein the method steps further comprise executing the method in response to no operation being performed on the computer for a predetermined time and display on the display being performed by a self-luminous element.

16. The program product according to claim 13, wherein the method steps further comprise executing the method in response to no operation being performed on the computer for a predetermined time and the computer being operated on battery power.

17. The program product according to claim 13, wherein the method steps further comprise executing the method in response to no operation being performed on the computer for a predetermined time and the full-screen window is not completely hidden by a different window already displayed.

18. The program product according to claim 13, wherein the method steps further comprise directing the multi-window OS to hide a window displayed in front of the full-screen window behind the full-screen window and/or display a window hidden behind the full-screen window in front of the full-screen window, in response to a window switching signal received in a state where the full-screen window is displayed.
